(19) United States
(12) Patent Application Publication
(10) Pub. No.: US 2009/0188114 A1
(43) Pub. Date: Jul. 30, 2009

(54) Cutting device and cutting method

(76) Inventors: Masami Adachi, Tokyo (JP); Masahiro Nakayama, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/585,453

(22) PCT Filed: Jan. 6, 2005
(86) PCT No.: PCT/JP2005/000079

§ 371 Date: Oct. 5, 2007

(30) Foreign Application Priority Data
Jan. 7, 2004 (JP) 2004-002282

(51) Int. Cl. B26B 7/00; B26D 3/00

(52) U.S. Cl. 30/140; 83/56

(57) ABSTRACT

A cutting device capable of heating a blade uniformly and to an appropriate temperature and capable of cutting a member with small cutting resistance at a low angle (acute angle) is provided. Electricity is passed through a metallic thin blade to cause the blade to self-heat, and this enables the blade to cut an unvulcanized rubber member with small resistance and with restricted deformation of the member. The thin blade is durable because of its strip shaped shape and can be uniformly heated because it self-heats by an electric current.

### TECHNICAL FIELD

The present invention relates to a cutting device and a cutting method that cut a flexible unvulcanized rubber member, and in particular to a cutting device and a cutting method that cut a strip shaped member diagonally with respect to its thickness direction and with restricted deformation of the member.

### BACKGROUND ART

Conventionally, when end portions of a strip shaped unvulcanized rubber member such as the tread of a tire are to be jointed, the unvulcanized rubber member is cut at a certain angle with respect to its thickness direction such that the joint surface becomes diagonal with respect to the member surface.

The reason for this is because, since the length of the cut rubber member may be vary, the affect that the length variation exerts on the weight balance can be reduced and the jointing work also becomes easier by making the joint surface diagonal.

As conventional methods of cutting an unvulcanized rubber member diagonally with respect to its thickness direction, cutting with a blade that has been heated by an electric heater or the like (see Japanese Patent Application Laid-open (JP-A) No. 8-207000), cutting with a rotary ring cutter, and cutting with an ultrasonic oscillation cutter have usually been employed.

### DISCLOSURE OF THE INVENTION

### Problems that the Invention is to Solve

Incidentally, in the jointing work step, there has been a demand to improve length variation retrieval by reducing the cutting angle.

However, in conventional cutting methods, a member cutting angle of 25° to 30° with respect to the member surface has been the limit, and when the member is cut at an angle smaller than this, deformation arises in the member due to an increase in cutting resistance, and it has been difficult to obtain the desired angle.

When the member cutting angle is reduced, the area of contact between the member and the blade increases and turning of the leading end portions occurs as the result of an increase in slip resistance, which may lead to the occurrence of defects in the product.

When jointing work is done in this state, the affect of variations in the joints on the product is great, and the burden on the worker is also great.

The best way to cut at a low angle may be to minimize cutting resistance.

In the case of a cutting device that Heats the blade with an electric heater, it would be ideal to cut with a blade having a string-like shape whose diameter is the smallest it can possibly be, but it is easy for the blade to break because its rigidity is small. A blade having a strip shaped shape (thickness of 1 to 3 mm, width of 10 to 25 mm) or the like is conceivable as a realistic shape.

However, a balance between heating and heat release cannot be achieved when the blade is heated with conventional heating methods, and it has been difficult to heat the blade edge to the required temperature.

Consequently, there has been used a blade (thickness of 5 to 7 mm, width of 100 to 200 mm, etc.) with a certain mass having a large heat capacity, but this is beset with problems such as an increase in cutting resistance resulting from the thick plate and an increase in the cutting angle, and also handling difficulty resulting from an increase in the heating period due to an increase in the mass of the blade.

Further, in the case of an ultrasonic oscillation cutter, in addition to the above problems as with the electric heating, it is easy to exceed the temperature limit because of uncontrollable frictional heat, it is difficult to control the temperature of the contact portion accordingly, there is the potential for the adhesive force to be deteriorated due to burning of the cutting surface.

The present invention has been made with taking the above-described problems into consideration, and is to provide a cutting device that is capably of heating a blade uniformly and to an appropriate temperature and is capable of cutting a member with small cutting resistance.

### Means for Solving the Problems

A cutting device recited in claim 1 includes: a strip shaped metallic thin blade; a power supply that passes an electric current through the thin blade to cause the thin blade to heat; and a drive part that causes the thin blade to move in contact with and apart from a member to be cut.

Next, the function of the cutting device recited in claim 1 will be described.

In the cutting device recited in claim 1, an electric current is passed through the metallic thin blade such that the blade itself beats.

The thermoplastic member to be cut, such as unvulcanized rubber, becomes flexible (or melts) as a result of being heated, and the strip shaped thin blade that has heated can cut the member with restricted deformation of the member. The cutting format of the present embodiment is the so-called guillotine format where the thin blade is moved in a thickness direction of the member.

Further, the entire blade can be uniformly heated because the blade itself heats by an electric current.

Moreover, the thin blade is durable in comparison to a string-like blade because of its strip like shape.

Further, it is possible to freely set the temperature across the entire width of the blade by controlling the electric current. Moreover, the blade can be made thin because the thin blade self-heats, this results in the temperature of the blade to speedily raise and lower because heating and heat release become faster. In addition, handling is easy which is advantageous in reducing maintenance time and ensuring safety.

In the case of a certain blade shape, the blade temperature becomes stable with respect to a certain current and does not rise beyond the certain temperature accordingly, an upper temperature limit can be assured and the occurrence of quality problems resulting from the rubber burning and the like can be prevented.

As described above, because the cutting device of an embodiment of the present invention has the above configuration, it has the excellent effect that it is capable of heating the thin blade uniformly and to an appropriate temperature and is capable of cutting the member, such as an unvulcanized rubber member, with small cutting resistance at a low angle (acute angle)

An invention recited in claim 2, the cutting device of claim 1 further includes a non-contact thermometer that measures the temperature of the thin blade without contacting the thin blade, and a controller that controls the electric current passing through the thin blade on the basis of a temperature detection signal from the non-contact thermometer.

Next, the function of the cutting device recited in claim 2 will be described.

When an electric current with a predetermined value is passed through the thin blade, the temperature of the thin blade gradually rises, and after a certain amount of time passes, the temperature stops rising and remains at a constant value.

In the cutting device recited in claim 2, the temperature of the thin blade can be measured by the thermometer. Thus, while the thermometer measures the temperature of the thin blade, the controller controls such that a large electric current is initially passed through the thin blade to reach a desired temperature and then the electric current is lowered, so that the temperature of the thin blade can be caused to quickly reach the desired temperature.

An invention recited in claim 3 is, in the cutting device of claim 1 or 2, the surface of the thin blade is coated with a low-friction material whose frictional resistance is less than that of the metal configuring the thin blade.

Next, the function of the cutting device recited in claim 3 will be described.

Because the surface of the thin blade is coated with a low-friction material whose frictional resistance is less than that of the metal configuring the thin blade, cutting resistance can be further reduced and deformation of the member to be cut can be further restricted.

An invention recited in claim 4 is the cutting device of any one of claims 1 to 3 further includes a tension applying part that applies tension to the thin blade.

Next, the function of the cutting device recited in claim 4 will be described.

The thin blade expands when the thin blade heats. Consequently, by applying a tension in advance in the longitudinal direction of the blade with the tension applying part, the thin blade can be prevented from being bent by resistance when it heats and when it cuts.

An invention recited in claim 5 is the cutting device of any one of claims 1 to 4 further includes a cutting condition changing part that enables a cutting angle and a diagonal angle to be changed. The cutting angle is an angle formed between a line indicating the moving direction of the thin blade and a line orthogonal to the thickness direction of the member to be cut and the diagonal angle is an inclination angle of the thin blade with respect to a direction orthogonal to a longitudinal direction of the member to be cut

Next, the function of the cutting device recited in claim 5 will be described.

The cutting angle that is formed between a line indicating the moving direction of the thin blade and a line orthogonal to the thickness direction of the member and the diagonal angle that is an inclination angle of the thin blade with respect to a direction orthogonal to a longitudinal direction of the member can be changed by the cutting condition changing part.

Consequently, the thin blade can be set to a cutting angle and a diagonal angle suited for the member to be cut, and the thin blade can cut the member at a desired cutting angle and with small resistance.

An invention recited in claim 6 is, in the cutting device of any one of claims 1 to 5, the thin blade is longer than the width of the member to be cut.

Next, the function of the cutting device recited in claim 6 will be described.

Because the length of the thin blade is set to be longer than the width of the member to be cut, the thin blade can efficiently cut the member as a result of the thin blade being moved in the thickness direction thereof.

An invention recited in claim 7 is a method of cutting a member to be cut using a metallic strip shaped thin blade that has been heated, the method includes: using a thin blade that is longer than the width of the member to be cut; and moving the thin blade when cutting the member, with a blade edge longitudinal direction that is slanted θb degrees with respect to a width direction orthogonal to a longitudinal direction of the member, and the thin blade moves with being slanted θa degrees with respect to a direction orthogonal to a thickness direction of the member.

In the cutting method recited in claim 7, the thin blade that is longer than the width of the member moves with a blade edge longitudinal direction that is slanted θb degrees with respect to a width direction orthogonal to a longitudinal direction of the member and the thin blade moves with being slanted at θa degrees with respect to a direction orthogonal to a thickness direction of the member.

For this reason, the thin blade can cut the member diagonally and with small resistance.

### BRIEF DESCRIPTION OF THE DRAWINGS

FIG. 1 is a perspective view of relevant portions of a cutting device pertaining to a first embodiment.

FIG. 2 is a block diagram of an electrical system in the cutting device pertaining to the first embodiment.

FIG. 3A is a cross-sectional view of a thin blade and an anvil along a rubber member conveyance direction.

FIG. 3B is a plan view of the thin blade and the anvil.

FIG. 4 is a perspective view of relevant portions of a cutting device pertaining to a second embodiment.

FIG. 5 is a block diagram of an electrical system in the cutting device pertaining to the second embodiment.

FIG. 6 is a graph showing the relationship between the temperature of a thin blade, an electric current, and time.

### BEST MODES FOR IMPLEMENTING THE INVENTION

Examples for implementing the present invention will be described in detail below with reference to the drawings.

### First Embodiment

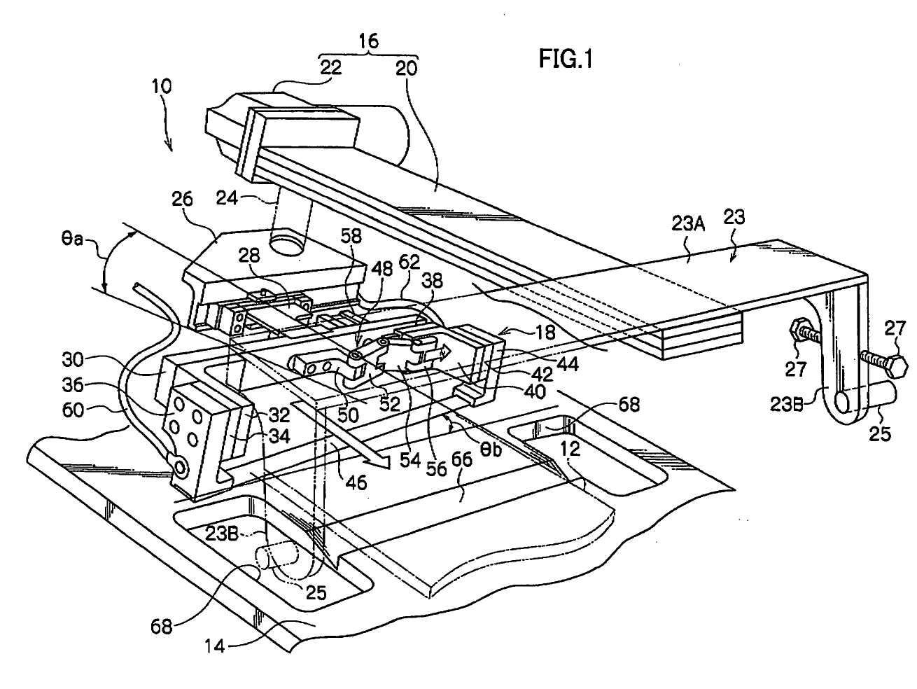

As shown in FIG. 1, a cutting device 10 of the present embodiment is disposed on a conveyance path that conveys an unvulcanized rubber member 12 that becomes the tread of a tire, for example.

A tabular anvil 14 that supports the underside of the unvulcanized rubber member 12 is horizontally disposed at lower part of the conveyance path.

A cutter head 18 that is moved by an electric actuator 16 is disposed above the anvil 14.

The electric actuator 16 is disposed with a guide rail 20 and a moving member 22 that is moved along the guide rail 20. It will be noted that the cutter head 18 may also be moved by another drive device such as an electric motor or an air cylinder.

The guide rail 20 is attached to a swinging frame 23 disposed such that it straddles the conveyance path of the unvulcanized rubber member 12.

A shaft 24 is attached to a lower end of the moving member 22, and a base 26 of the cutter head 18 is rotatably supported on the shaft 24. It will be noted that an unillustrated lock mechanism that deters rotation with respect to the shaft 24 is disposed on the base 26.

A long frame 30 is attached to a side surface of the base 26 via a support member 28.

The long frame 30 is disposed in the horizontal direction, and an L-shaped first electrode support frame 32 is attached to one end side.

A first strip shaped blade attachment member 36 that is made of metal is attached to the first electrode support frame 32 via an insulator 34.

A second electrode support frame 40 is attached to the other end side of the long frame 30 via a linear slide bearing 38. The second electrode support frame 40 is configured such that it can freely slide in the longitudinal direction of the long frame 30.

A second strip shaped blade attachment member 44 that is made of metal is attached to the second electrode support frame 40 via an insulator 42.

One end of a strip shaped thin blade 46 is attached to the first strip shaped blade attachment member 36 and the other end of the strip shaped thin blade 46 is attached to the second strip shaped blade attachment member 44 with unillustrated bolts.

The thin blade 46 of the present embodiment is made of steel, has a width of 12 mm, a length of 350 mm, and a thickness of 1.8 mm, and its surface is coated with fluororesin.

The long frame 30 and the second electrode support frame 40 are coupled together via a tension device 48.

The tension device 48 is disposed with a first fixed member 50 that is attached to the long frame 30, a first link 52 that is swingably supported on the fixed member 50, a second link 54 that is swingably supported on the first link 52, and a second fixed member 56 that is attached to the second electrode support frame 40 and swingably supports the second link 54, all of which configure a toggle link. The tension device 48 further includes an adjustment device 58 that is attached to the long frame 30 and pushes and pulls the second link 54. The second electrode support frame 40 is moved in directions toward and away from the first electrode support frame 32 by pushing and pulling the second link 54 with the adjustment device 58 so that a tension is applied to the thin blade 46.

Here, one end of a first electrical wire 60 is attached to the first strip shaped blade attachment member 36, and one end of a second electrical wire 62 is attached to the second strip shaped blade attachment member 44.

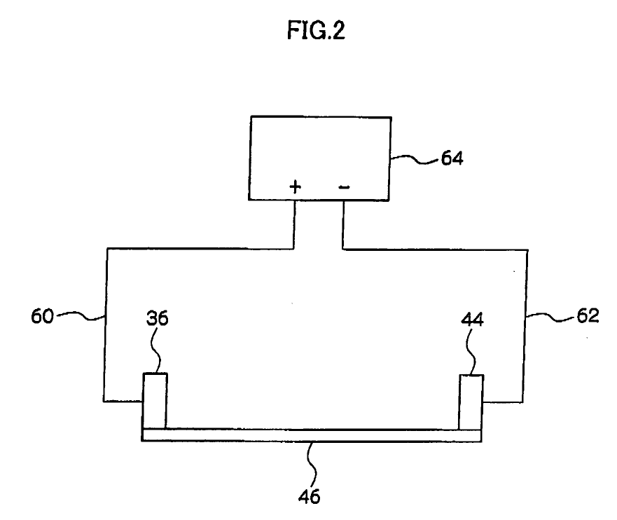

As shown in FIG. 2, the other end of the first electrical wire 60 and the other end of the second electrical wire 62 are connected to a power supply 64.

It will be noted that the power supply 64 can vary the voltage and electric current passing through the thin blade 46.

As shown in FIG. 1, the swinging frame 23 that supports the guide rail 20 is disposed with a base plate 23A, which extends in a direction orthogonal to the longitudinal direction (conveyance direction) of the unvulcanized rubber member 12, and side plates 23B, which extend downward from both end portions of the base plate 23A.

The guide rail 20 is attached to the underside of the base plate 23A such that the guide rail is oriented in the longitudinal direction (conveyance direction) of the unvulcanized rubber member 12.

Shafts 25 are inserted into the vicinities of the lower ends of the side plates 23B such that the shafts can freely rotate, and the swinging frame 23 is swingable around the shafts 25.

Bolts 27 attached to a body frame fixed to an unillustrated floor surface are disposed in both sides of one of the side plates 23B such that the bolts 27 face each other.

The leading ends of the bolts 27 push against the end portions of the side plate 23B and fix the swinging frame 23 such that, when seen from the side of the conveyance path, the guide rail 20 is slanted at an angle (same as a later-described cutting angle) θa with respect to the horizontal direction.

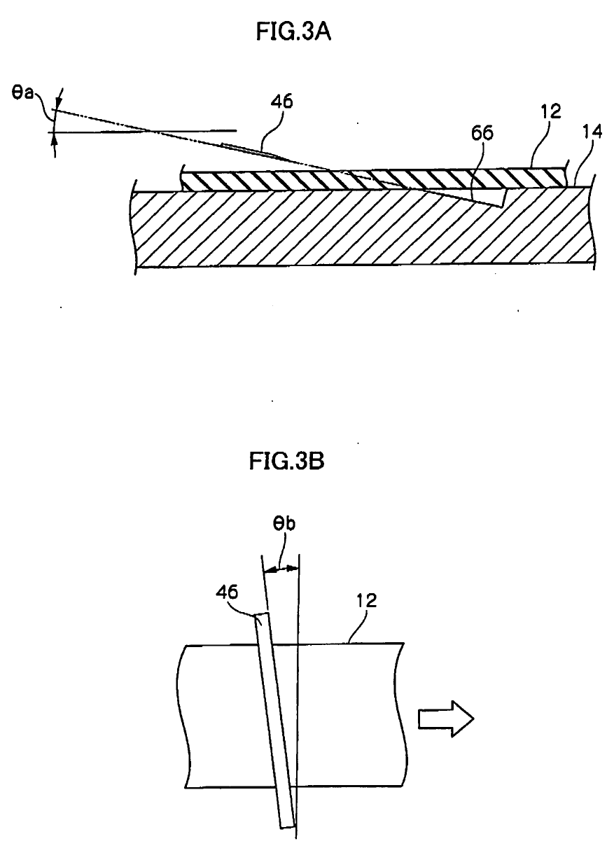

Because the thin blade 46 is attached parallel to the guide rail 20, the moving member 22 is moved to enable the thin blade 46 to cut the unvulcanized rubber member 12 placed on the upper surface of the anvil 14 at a cutting angle θa, as shown in FIG. 3(A)

In the present embodiment, the cutting angle θa can be changed by adjusting the bolts 27.

As shown in FIG. 1 and FIG. 3(A), a relief 66 of the thin blade 46 is formed in the upper surface of the anvil 14, and relieves 68 of the first strip shaped blade attachment member 36 and the second strip shaped blade attachment member 44 are formed on both sides of the relief 66.

Further, because the base 26 of the cutter head 18 is rotatably supported, as shown in FIG. 3(B), a diagonal angle θb of the thin blade 46 with respect to a direction orthogonal to the conveyance direction when the unvulcanized rubber member 12 is seen from directly overhead can be changed in the range of 0 to 45°, for example.

### (Function)

Next, the function of the cutting device 10 of the present embodiment will be described.

When the unvulcanized rubber member 12 is cut, first, the unvulcanized rubber member 12 is conveyed such that the cutting site is disposed on the upper portion of the anvil 14.

Next, electricity is passed through the thin blade 46 to cause the thin blade 46 self-heat.

When the electric current flows through the steel thin blade 46, the temperature of the thin blade 46 gradually rises and becomes constant at a certain value because a balance is achieved between heating and heat release of the thin blade 46 (so-called saturation condition). Consequently, an electric current value that causes the thin blade to reach a temperature that is optimum for cutting the unvulcanized rubber member 12 is checked for in advance, and the power supply 64 is set in advance such that this electric current value is reached.

The moving member 22 is slid diagonally downward along the guide rail 20, whereby the unvulcanized rubber member 12 is cut by the heated thin blade 46 diagonally with respect to its surface.

The thin blade 46 is capable of cutting the unvulcanized rubber member 12 with small resistance and with restricted deformation of the member because the blade is heated entirely and its surface is coated with a low-friction material.

In the present embodiment, because the thin blade 46, which is heated, is thin and has a narrow width, is employed, it is possible to make the cutting angle θa 10° or less, for example, and cut the unvulcanized rubber member 12 without causing deformation of the unvulcanized rubber member 12.

By making the cutting angle θa a low angle of 10° or less, in the case of an overlap joint where the cut portions (taper portions) are overlapped, changes in the mass of the joint portion (tire circumferential direction) can be reduced, tire product defects stemming from the joint, such as variations in uniformity, product unevenness, and bare portions, can be reduced, which can contribute to the stability of the tire performance.

It will be noted that there are proper saturation temperatures in individual blade shapes and materials depending on the electric current passing through the thin blade 46, and that by controlling or limiting the electric current, the optimum cutting temperature and the upper temperature limit can be freely set, and optimum cutting conditions and quality assurance for the unvulcanized rubber member are settable.

Here, the cutting angle θa is set in order to obtain appropriate joint performance of the products, it suffices for the cutting angle θa to be 20° or less, and as mentioned above, it is preferable for the cutting angle θa to be 10° or less.

Further, it is preferable to set the diagonal angle θb of the thin blade 46 to about 0 to 45°. When the diagonal angle θb is large, the moving stroke of the thin blade 46 increases but becomes advantageous in reducing cutting resistance.

It will be noted that the thin blade 46 can be easily replaced by pivoting the cutter head 18 and orienting the thin blade 46 in the lateral direction of the conveyance path.

In the present embodiment, the steel thin blade 46, which has a width of 12 mm, a length of 350 mm, and a thickness of 1.8 mm, was used, but the width, length, thickness, and material of the thin blade 46 are not limited to these.

When the thin blade 46 cut the unvulcanized rubber material 12, it is preferable for the thickness of the thin blade 46 to be in the range of 1.0 to 3.0 mm and for the width of the thin blade 46 to be in the range of 10 to 20 nm.

### Second Embodiment

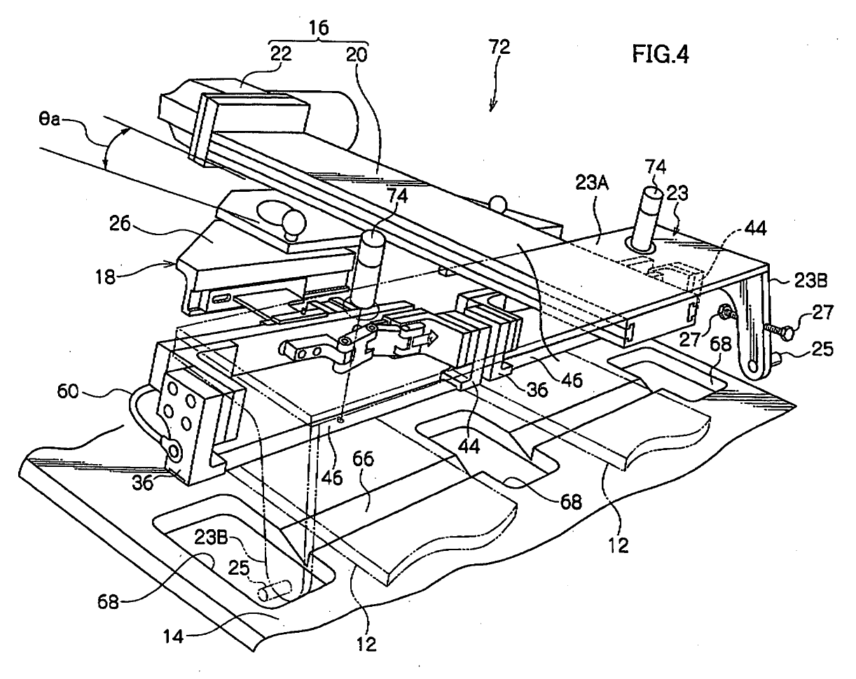

Next, a cutting device 72 pertaining to a second embodiment of the present invention will be described in accordance with FIG. 4 to FIG. 6. It will be noted that the same reference numerals will be given to the same configurations as those of the first embodiment, and that description thereof will be omitted.

As shown in FIG. 4, in the present embodiment, a pair of thin blades 46 is disposed on the base 26.

Further, a non-contact infrared thermometer 74 is disposed above each of the thin blades 46.

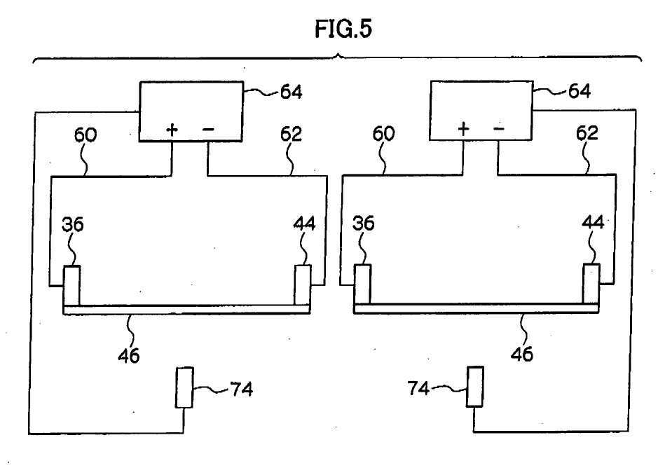

As shown in FIG. 5, the infrared thermometers 74 are connected to power supplies 64.

The power supplies 64 of the present embodiment include controllers capable of controlling the electric current on the basis of the temperatures of the thin blades 46 measured by the infrared thermometers 64.

### (Action)

Next, the action of the present embodiment will be described.

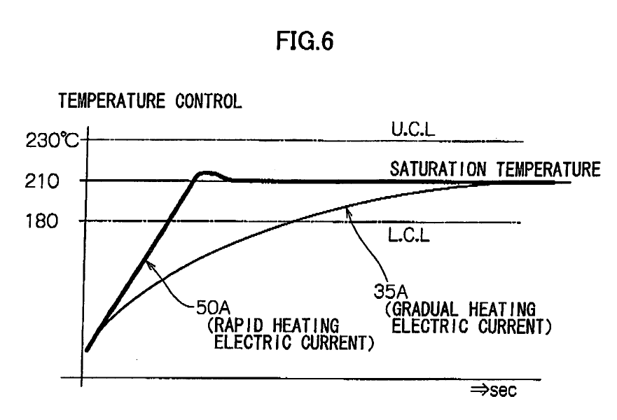

In the case of the thin blades 46 of the present embodiment, which are made of steel, have widths of 12 mm, lengths of 350 mm, and thicknesses of 1.8 mm, when the voltage and the electric current applied to the thin blades 46 are set to 9 V and 35 A, for example, the temperatures of the thin blades 46 gradually rise and become constant at 210° C. when a balance is achieved between heating and heat release of the thin blades 46 (so-called saturation condition), as shown in FIG. 6.

In the present embodiment, the power supplies 64 initially apply to the thin blades 46 the voltage and the electric current set to 9 V and 50 A. Thus, the thin blades 46 can be more rapidly heated than when the voltage and electric current of 9 V and 35 A are applied and can reach the intended temperature (210° C.) in a short period of time.

When the temperatures of the thin blades 46 is measured such that the temperature has reached the intended temperature by the infrared thermometers 74, the electric current is lowered to 35 A to make the temperatures of the thin blades 46 constant.

It will be noted that the other function and effects are the same as those of the first embodiment.

### INDUSTRIAL APPLICABILITY

The present invention can be used to cut a member with small cutting resistance.

1. A cutting device comprising:
a strip shaped metallic thin blade;
a power supply that passes an electric current through the thin blade to cause the thin blade to heat; and
a drive part that causes the thin blade to move in a thickness direction of a member to be cut.

2. The cutting device of claim 1, further comprising
a non-contact thermometer that measures the temperature of the thin blade without contacting the thin blade, and
a controller that controls the electric current passing through the thin blade on the basis of a temperature detection signal from the non-contact thermometer.

3. The cutting device of claim 1, wherein the surface of the thin blade is coated with a low-friction material whose frictional resistance is less than that of the metal configuring the thin blade.

4. The cutting device of claim 1, further comprising a tension applying part that applies tension to the thin blade.

5. The cutting device of claim 1, further comprising a cutting condition changing part that enables a cutting angle and a diagonal angle to be changed wherein, the cutting angle is an angle formed between a line indicating the moving direction of the thin blade and a line orthogonal to the thickness direction of the member to be cut; and the diagonal angle is an inclination angle of the thin blade with respect to a direction orthogonal to a longitudinal direction of the member to be cut.

6. The cutting device of claim 1, wherein the thin blade is longer than the width of the member to be cut.

7. A method of cutting a member to be cut with a metallic strip shaped thin blade that has been heated, the method comprising:
passing an electric current through a thin blade that is longer than the width of the member to be cut to cause the thin blade to heat; and
moving the thin blade when cutting the member with a blade edge longitudinal direction that is slanted θb degrees with respect to a width direction orthogonal to a longitudinal direction of the member, and with the thin blade slanted at θa degrees with respect to a direction orthogonal to a thickness direction of the member.
